(19) United States
(12) Patent Application Publication
(10) Pub. No.: US 2024/0079733 A1
(43) Pub. Date: Mar. 7, 2024

(54) FAST ENGAGING-DISENGAGING CONNECTORS FOR CELL-TO-SYSTEM BATTERY DESIGN

(71) Applicant: Enphase Energy, Inc., Petaluma, CA (US)

(72) Inventors: Wei JIANG, Round Rock, TX (US); Christopher McNair LYKE, Austin, TX (US); Chris Morrow Young, Round Rock, TX (US)

(21) Appl. No.: 18/234,072

(22) Filed: Aug. 15, 2023

Related U.S. Application Data
(60) Provisional application No. 63/403,512, filed on Sep. 2, 2022.

(51) Int. Cl. H01M 50/519; H01M 10/42; H01M 50/503; H01M 50/516; H01M 50/517; H01M 50/522; H01M 50/524; H01M 50/562; H01M 50/569; H02J 7/00

(52) U.S. Cl. CPC H01M 50/519; H01M 10/425; H01M 50/503; H01M 50/516; H01M 50/517; H01M 50/522; H01M 50/524; H01M 50/562; H01M 50/569; H02J 7/0068

(57) ABSTRACT

The present disclosure provides an energy storage system. For example, an energy storage system comprises a printed circuit board assembly configured to connect to a chassis of the energy storage system and a battery cell comprising a connecting/disconnecting device configured to engage a corresponding connecting/disconnecting device on the printed circuit board assembly for providing at least one of electrical interconnection, routing, voltage sensing, or temperature sensing.

### CROSS-REFERENCE TO RELATED APPLICATIONS

This application claims the benefit of and priority to U.S. Provisional Application Ser. No. 63/403,512, filed on Sep. 2, 2022, the entire contents of which is incorporated herein by reference.

### BACKGROUND

### Field of the Disclosure

Embodiments of the present disclosure relate generally to energy storage systems, and, for example, to fast engaging-disengaging connectors for cell-to-system battery design.

### Description of the Related Art

Conventional energy storage systems (battery systems) can comprise one or more cells that connect one or more PCBA (printed circuit board assemblies) via one or more terminal connectors. For example, cylindrical cell configurations can be electrically connected to the PCBA using spot or wedge welding on metal bus bars or by using bolts to connect cells with threaded tabs. As such an approach mostly requires automatic welding lines, field replacement of problematic cells to avoid unnecessary RMA of an entire battery module is not possible or can be extremely difficult to conduct (e.g., each screw must be removed layer by layer).

Similarly, prismatic cell configurations can be electrically connected to the PCBA using screws (e.g., cells with threaded tabs) or spot welding (e.g., cells with smooth tabs). Such an approach requires connecting sensing cables to the PCBA and can be time consuming and hard to automate. Additionally, using spot welded FPC (flexible printed circuit) for sensing battery voltage and temperature, field replacement of the cells can be hard to disconnect and can have reliability concerns after reconnection).

Likewise, pouch cell configurations can be electrically connected using either welding (e.g., ultrasonic, laser, etc.) or screws. The former, however, is not suitable for field replacement of cells, and the latter is a complex assembling process (i.e., a requires sorting out the tabs, screw securing the tabs on to a bus bar, and/or connecting sensing cables).

While the aforementioned methods are suitable for connecting the various cell configurations, such methods are not configured for fast engagement/assembling without heavy investment in equipment and are not configured for fast disengagement to enable field replacement of cells.

Accordingly, there is a need for improved fast engaging-disengaging connectors for cell-to-system battery design.

### SUMMARY

Energy storage systems are provided herein. For example, in at least some embodiments, an energy storage system comprises a printed circuit board assembly configured to connect to a chassis of the energy storage system and a battery cell comprising a connecting/disconnecting device configured to engage a corresponding connecting/disconnecting device on the printed circuit board assembly for providing at least one of electrical interconnection, routing, voltage sensing, or temperature sensing.

In accordance with at least some aspects of the disclosure, an energy management system comprises a distributed energy resource comprising a renewable energy source, a load center connected to the renewable energy source, and an energy storage system, comprising a printed circuit board assembly configured to connect to a chassis of the energy storage system and a battery cell comprising a connecting/disconnecting device configured to engage a corresponding connecting/disconnecting device on the printed circuit board assembly for providing at least one of electrical interconnection, routing, voltage sensing, or temperature sensing.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only typical embodiments of this disclosure and are therefore not to be considered limiting of its scope, for the disclosure may admit to other equally effective embodiments.

FIG. 1 is a block diagram of an energy management system, in accordance with one or more embodiments of the present disclosure;

FIGS. 2A-2C are diagrams of cylindrical cell electrical configurations, in accordance with one or more embodiments of the present disclosure;

FIGS. 3A-3C are diagrams of prismatic cell electrical configurations, in accordance with one or more embodiments of the present disclosure; and

FIGS. 4A-4D are diagrams of pouch cell electrical configurations, in accordance with one or more embodiments of the present disclosure.

### DETAILED DESCRIPTION

Embodiments of the present disclosure relate to fast engaging-disengaging connectors for cell-to-system battery design. For example, an energy storage system comprises a printed circuit board assembly configured to connect to a chassis of the energy storage system. A battery cell comprises a connecting/disconnecting device configured to engage a corresponding connecting/disconnecting device on the printed circuit board assembly for providing at least one of electrical interconnection, routing, voltage sensing, or temperature sensing. The apparatus described herein provide for a relatively quick connect and disconnect of battery cells to a PCBA without the need of expensive components. Additionally, the apparatus described herein provide relatively easy field replacement of battery cells, thus alleviating the need for total module RMA (return material authorization) and provides potential commercial advantages to sale.

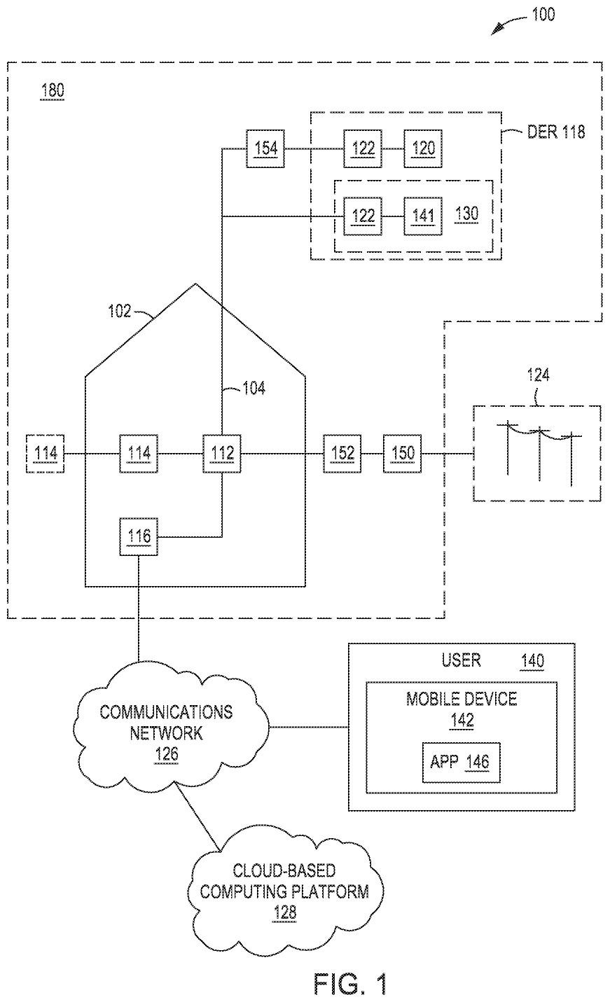

FIG. 1 is a block diagram of a system 100 (e.g., an energy management system or power conversion system) in accordance with one or more embodiments of the present disclosure. The diagram of FIG. 1 only portrays one variation of the myriad of possible system configurations. The present disclosure can function in a variety of environments and systems.

The system 100 comprises a structure 102 (e.g., a user's structure), such as a residential home or commercial building, having an associated DER 118 (distributed energy resource). The DER 118 is situated external to the structure 102. For example, the DER 118 may be located on the roof of the structure 102 or can be part of a solar farm. The structure 102 comprises one or more loads (e.g., appliances, electric hot water heaters, thermostats/detectors, boilers, water pumps, and the like), one or more energy storage devices (an energy storage system 114), which can be located within or outside the structure 102, and a DER controller 116, each coupled to a load center 112. Although the energy storage system 114, the DER controller 116, and the load center 112 are depicted as being located within the structure 102, one or more of these may be located external to the structure 102. In at least some embodiments, the energy storage system 114 can be, for example, one or more of the energy storage devices (e.g., IQ Battery 10®) commercially available from Enphase® Inc. of Petaluma, CA. Other energy storage devices from Enphase® Inc. or other manufacturers may also benefit from the inventive methods and apparatus disclosed herein.

The load center 112 is coupled to the DER 118 by an AC bus 104 and is further coupled, via a meter 152 and a MID 150 (e.g., microgrid interconnect device), to a grid 124 (e.g., a commercial/utility power grid). The structure 102, the energy storage system 114, DER controller 116, DER 118, load center 112, generation meter 154, meter 152, and MID 150 are part of a microgrid 180. It should be noted that one or more additional devices not shown in FIG. 1 may be part of the microgrid 180. For example, a power meter or similar device may be coupled to the load center 112.

The DER 118 comprises at least one renewable energy source (RES) coupled to power conditioners 122. For example, the DER 118 may comprise a plurality of RESs 120 coupled to a plurality of power conditioners 122 in a one-to-one correspondence (or two-to-one). In embodiments described herein, each RES of the plurality of RESs 120 is a photovoltaic module (PV module), although in other embodiments the plurality of RESs 120 may be any type of system for generating DC power from a renewable form of energy, such as wind, hydro, and the like. The DER 118 may further comprise one or more batteries (or other types of energy storage/delivery devices) coupled to the power conditioners 122 in a one-to-one correspondence, where each pair of power conditioner 122 and a DC battery 141 may be referred to as an AC battery 130.

The power conditioners 122 invert the generated DC power from the plurality of RESs 120 and/or the DC battery 141 to AC power that is grid-compliant and couple the generated AC power to the grid 124 via the load center 112. The generated AC power may be additionally or alternatively coupled via the load center 112 to the one or more loads and/or the energy storage system 114. In addition, a power conditioner coupled to DC the battery converts AC power from the AC bus 104 to DC power for charging the DC battery 141. A generation meter 154 is coupled at the output of the power conditioners 122 that are coupled to the plurality of RESs 120 in order to measure generated power.

In some alternative embodiments, the power conditioners 122 may be AC-AC converters that receive AC input and convert one type of AC power to another type of AC power. In other alternative embodiments, the power conditioners 122 may be DC-DC converters that convert one type of DC power to another type of DC power. In some of embodiments, the DC-DC converters may be coupled to a main DC-AC inverter for inverting the generated DC output to an AC output.

The power conditioners 122 may communicate with one another and with the DER controller 116 using power line communication (PLC), although additionally and/or alternatively other types of wired and/or wireless communication may be used. The DER controller 116 may provide operative control of the DER 118 and/or receive data or information from the DER 118. For example, the DER controller 116 may be a gateway that receives data (e.g., alarms, messages, operating data, performance data, and the like) from the power conditioners 122 and communicates the data and/or other information via the communications network 126 to a cloud-based computing platform 128, which can be configured to execute one or more application software, e.g., a grid connectivity control application, to a remote device or system such as a master controller (not shown), and the like. The DER controller 116 may also send control signals to the power conditioners 122, such as control signals generated by the DER controller 116 or received from a remote device or the cloud-based computing platform 128. The DER controller 116 may be communicably coupled to the communications network 126 via wired and/or wireless techniques. For example, the DER controller 116 may be wirelessly coupled to the communications network 126 via a commercially available router. In one or more embodiments, the DER controller 116 comprises an application-specific integrated circuit (ASIC) or microprocessor along with suitable software (e.g., a grid connectivity control application) for performing one or more of the functions described herein. For example, the DER controller 116 can include a memory (e.g., a non-transitory computer readable storage medium) having stored thereon instructions that when executed by a processor perform a method for grid connectivity control, as described in greater detail below.

The generation meter 154 (which may also be referred to as a production meter) may be any suitable energy meter that measures the energy generated by the DER 118 (e.g., by the power conditioners 122 coupled to the plurality of RESs 120). The generation meter 154 measures real power flow (kWh) and, in some embodiments, reactive power flow (kVAR). The generation meter 154 may communicate the measured values to the DER controller 116, for example using PLC, other types of wired communications, or wireless communication. Additionally, battery charge/discharge values are received through other networking protocols from the AC battery 130 itself.

The meter 152 may be any suitable energy meter that measures the energy consumed by the microgrid 180, such as a net-metering meter, a bi-directional meter that measures energy imported from the grid 124 and well as energy exported to the grid 124, a dual meter comprising two separate meters for measuring energy ingress and egress, and the like. In some embodiments, the meter 152 comprises the MID 150 or a portion thereof. The meter 152 measures one or more of real power flow (kWh), reactive power flow (kVAR), grid frequency, and grid voltage.

The MID 150, which may also be referred to as an island interconnect device (IID), connects/disconnects the microgrid 180 to/from the grid 124. The MID 150 comprises a disconnect component (e.g., a contactor or the like) for physically connecting/disconnecting the microgrid 180 to/from the grid 124. For example, the DER controller 116 receives information regarding the present state of the system from the power conditioners 122, and also receives the energy consumption values of the microgrid 180 from the meter 152 (for example via one or more of PLC, other types of wired communication, and wireless communication), and based on the received information (inputs), the DER controller 116 determines when to go on-grid or off-grid and instructs the MID 150 accordingly. In some alternative embodiments, the MID 150 comprises an ASIC or CPU, along with suitable software (e.g., an islanding module) for determining when to disconnect from/connect to the grid 124. For example, the MID 150 may monitor the grid 124 and detect a grid fluctuation, disturbance or outage and, as a result, disconnect the microgrid 180 from the grid 124. Once disconnected from the grid 124, the microgrid 180 can continue to generate power as an intentional island without imposing safety risks, for example on any line workers that may be working on the grid 124.

In some alternative embodiments, the MID 150 or a portion of the MID 150 is part of the DER controller 116. For example, the DER controller 116 may comprise a CPU and an islanding module for monitoring the grid 124, detecting grid failures and disturbances, determining when to disconnect from/connect to the grid 124, and driving a disconnect component accordingly, where the disconnect component may be part of the DER controller 116 or, alternatively, separate from the DER controller 116. In some embodiments, the MID 150 may communicate with the DER controller 116 (e.g., using wired techniques such as power line communications, or using wireless communication) for coordinating connection/disconnection to the grid 124.

A user 140 can use one or more computing devices, such as a mobile device 142 (e.g., a smart phone, tablet, or the like) communicably coupled by wireless means to the communications network 126. The mobile device 142 has a CPU, support circuits, and memory, and has one or more applications 146 (e.g., a grid connectivity control application) installed thereon for controlling the connectivity with the grid 124 as described herein. The one or more applications 146 may run on commercially available operating systems, such as 10S, ANDROID, and the like.

In order to control connectivity with the grid 124, the user 140 interacts with an icon displayed on the mobile device 142, for example a grid on-off toggle control or slide, which is referred to herein as a toggle button. The toggle button may be presented on one or more status screens pertaining to the microgrid 180, such as a live status screen (not shown), for various validations, checks and alerts. The first time the user 140 interacts with the toggle button, the user 140 is taken to a consent page, such as a grid connectivity consent page, under setting and will be allowed to interact with toggle button only after he/she gives consent.

Once consent is received, the scenarios below, listed in order of priority, will be handled differently. Based on the desired action as entered by the user 140, the corresponding instructions are communicated to the DER controller 116 via the communications network 126 using any suitable protocol, such as HTTP(S), MQTT(S), WebSockets, and the like. The DER controller 116, which may store the received instructions as needed, instructs the MID 150 to connect to or disconnect from the grid 124 as appropriate.

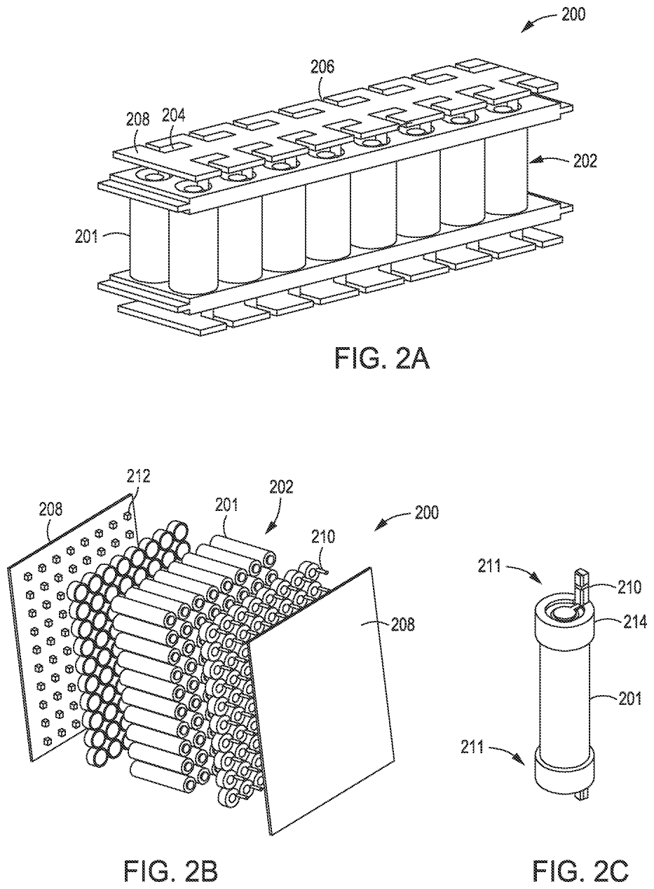

FIGS. 2A-2C are diagrams of cylindrical cell electrical configurations, in accordance with one or more embodiments of the present disclosure. For example, in FIG. 2A, a cylindrical cell electrical configuration 200 can comprise a plurality of battery cells 202 comprising a connecting/disconnecting device 204 configured to engage a connecting/disconnecting device 206 on a PCBA 208 (an integrated PCBA) for providing at least one of electrical interconnection, routing, voltage sensing, or temperature sensing. In at least some embodiments, the PCBA 208 can be configured for providing electrical interconnection and routing. The PCBA 208 can be configured for use with one or more energy storage devices (e.g., the energy storage system 114), such as the storage system disclosed in commonly-owned U.S. patent application Ser. No. 17/145,793, filed Jan. 11, 2021 and entitled “Storage System Configured For Use With An Energy Management System,” the entire contents of which is incorporated herein by reference.

The connecting/disconnecting device 206 of the PCBA 208 comprises an aperture, slot or the like, and the connecting/disconnecting device 204 of a battery cell 201 of the plurality of battery cells 202 comprises a metal tab configured to be received/positioned within the slot and attached thereto. In at least some embodiments, the metal tab can be positioned within the slot and bent toward the PCBA 208 and soldered (or spot welded) to the PCBA 208. The metal tab can be made from metals including, but not limited to, Nickel, Silver, Copper, Aluminum, or other metal that is suitable for spot welding and/or soldering.

In use, when a battery cell 201 needs to be replaced (e.g., removal of a bad battery cell), a metal tab of the battery cell 201 that needs to be replaced can be cut, and the bad battery cell can be removed from the PCBA 208 and replaced with a new battery cell. For example, the new battery cell, which comprises a new metal tab, can be attached to the PCBA 208 by positioning the new metal tab of the new battery cell within the slot of the PCBA 208 and spot welding or soldering the new metal tab to the old metal tab still positioned on the PCBA 208. In at least some embodiments, the old metal tab can be completely removed if needed.

FIGS. 2B and 2C illustrate an alternative embodiment of a connecting/disconnecting device of the plurality of battery cells 202 and the PCBA 208. For example, instead of spot welding the plurality of battery cells 202 to the PCBA 208, a battery cell can comprise a quick connect component 211 (e.g., a protrusion 210 and a base 214) that can be plugged/inserted into a socket 212 disposed on the PCBA 208 (e.g., for electrical interconnection, routing, voltage sensing, or temperature sensing). In at least some embodiments, the PCBA 310 can be configured for providing electrical interconnection and routing. The socket 212 and the quick connect component 211 can each be made from at least one of plastic or metal. In at least some embodiments, the socket 212 and the quick connect component 211 can be made from plastic. Additionally, the protrusion 210 can extend vertically from the base 214, which can be at least one of spot welded or soldered to at least one side of a battery cell 201. In the illustrated embodiment, each battery cell 201 comprises two quick connect components (e.g., a top quick connect component and a bottom quick connect component). In at least some embodiments, the protrusion 210 and the base 214 can be monolithically formed (e.g., as unitary component).

In use, when a battery cell 201 needs to be replaced, one or both of the PCBA can be removed from the plurality of battery cells by pulling the PCBA 208 from the plurality of battery cells 202 to disengage the protrusions from the sockets, so that the bad battery cell can be removed from the PCBA 208 and replaced with a new battery cell. For example, the new battery cell, which comprises a new protrusion, can be attached to the PCBA 208 by positioning the new protrusion of the new battery cell and the remaining protrusions of the other battery cells within the sockets of the PCBA 208 to reattach the PCBA 208 to the plurality of battery cells.

The integrated PCBA 208 is configured to connect to a chassis of the energy storage system. For example, the PCBA can be one of embedded in the chassis or connected to the chassis using at least one of nuts, bolts, screws, or adhesives. Additionally, the PCBA 208 is of conventional construction and can comprise a base, one or more signal processing components, one or more electrical traces, and one or more connection modules, all not shown. The base can be made of one or more suitable materials typically used for PCBA fabrication.

The one or more signal processing components can be built into (embedded) the base and can comprise sensing components/circuits that can operably communicate (via a wired or wireless configuration) with one or more components of the system 100 (e.g., the DER controller 116, the load center 112, etc.). For example, the one or more signal processing components can be configured to transmit/receive battery cell data to/from the DER controller 116, the load center 112, and/or a battery management unit (BMU) of the energy storage system 114. The battery cell data can comprise, for example, battery connection data (e.g., whether the PCBA 208 is connected to the battery cells), battery status data (e.g., charge of battery), etc.

The one or more electrical traces can be formed from one or more suitable conductive materials (e.g., copper, silver, gold, etc.) and are configured to electrically connect the one or more connectors and/or the one or more signal processing components to each other. The one or more electrical traces can be disposed on a top surface of the base of the PCBA 208, or the one or more traces can be embedded in the base.

The one or more connection modules can be configured to connect to a BMU (not shown). For example, in at least some embodiments, two of the one or more connectors are dedicated for connection to a BMU. In at least some embodiments, the connectors dedicated for connection to a BMU can correspond to a positive terminal and a negative terminal.

As described above, disposed along the base are one or more connectors/disconnectors (e.g., slots, sockets, or other type of connector) configured to connect to one or more battery cells, e.g., to connect to cylindrical battery cells, prismatic battery cells, or pouch battery cells.

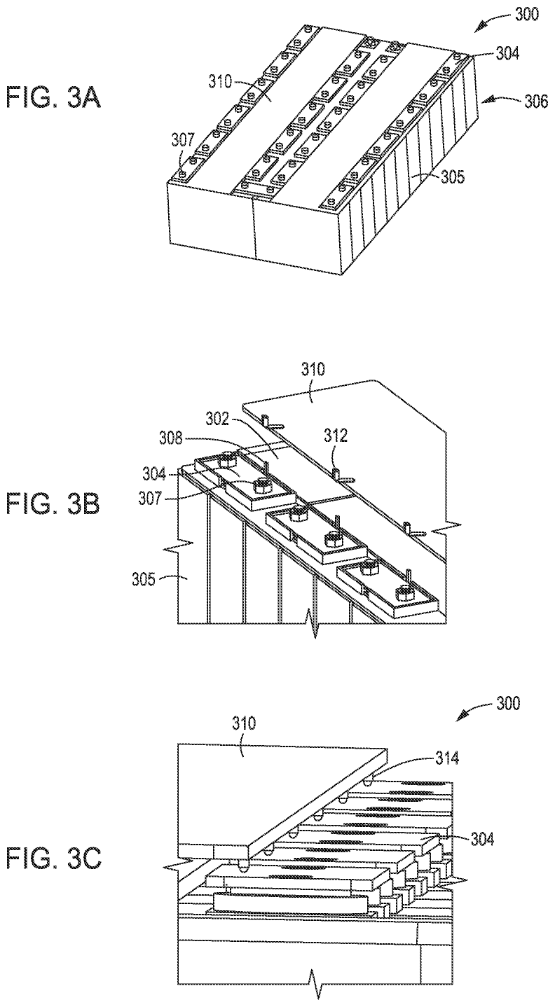

For example, FIGS. 3A-3C are diagrams of prismatic cell electrical configurations 300, in accordance with one or more embodiments of the present disclosure. In FIGS. 3A-3C an overlay 302 (or mask, which can be made from plastic or metal) can be embedded with one or more bus bars 304 that are connected to the plurality of battery cells 306 with bolts 307, screws or other suitable connection device. The plastic overlay 302 has one or more quick connect/disconnect devices 308 (e.g., a second electrical connector, such as a pre-welded pin) that extend from a top surface of the overlay 302 and plug into (e.g., releasably connect) a first electrical connector 312 (e.g., corresponding first electrical connector) disposed on a PCBA 310 (or the BMU), e.g., for providing at least one of electrical interconnection, routing, voltage sensing, or temperature sensing. In at least some embodiments, the PCBA 310 can be configured for providing voltage sensing or temperature sensing. In at least some embodiments, such as when the PCBA 310 comprises pogo pins 314 (e.g., spring-loaded), the pre-welded pin and the first electrical connector can be omitted. The PCBA 310 with the pogo pins 314 can be secured to a chassis with a mechanism such as brackets or holders. The pogo pins 314 can be pressed down to establish contact with busbars (e.g., the bus bars 304) and serve as a pathway of voltage and temperature sensing. The additional advantages are that the pogo pins 314 can handle vibration or thermal expansion of the battery cells 306 or one or more other components because of the springs inside of the pogo pins 314.

In use, when a battery cell 305 needs to be replaced, the PCBA 310 can be removed from the plurality of battery cells 306 by pulling the PCBA 310 from the plurality of battery cells 306 to disengage the one or more quick connect/disconnect devices 308 from the first electrical connector 312. Thereafter, the bolts 307 and the overlay 302 with the one or more bus bars 304 can be removed so that the bad battery cell can be removed and replaced with a new battery cell. Once replaced, all components can be reattached. For example, a new battery cell can be reattached to/rejoined with the plurality of battery cells 306, and the overlay 302 with the one or more bus bars 304 can be reattached to the plurality of battery cells 306 (e.g., using the bolts 307), and the PCBA 310 can reconnected to the plurality of battery cells via connecting the one or more quick connect/disconnect devices 308 to the first electrical connector 312.

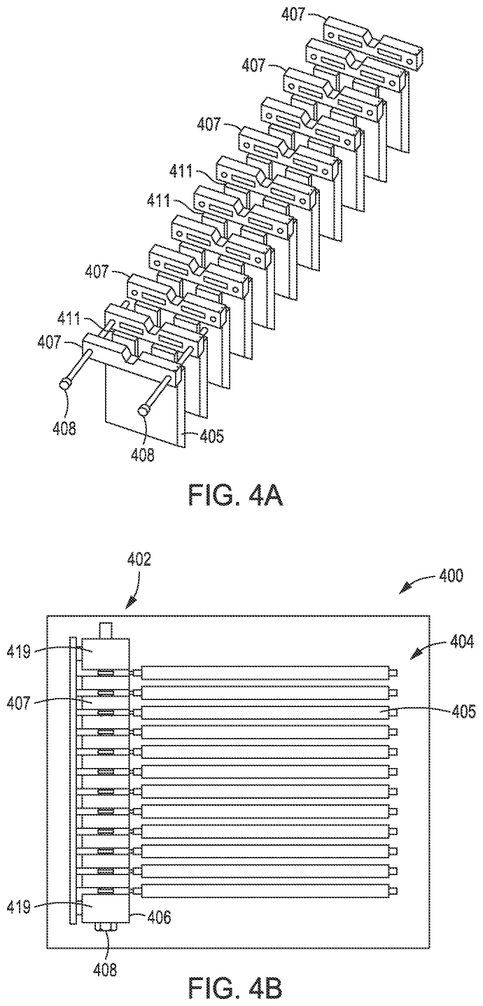

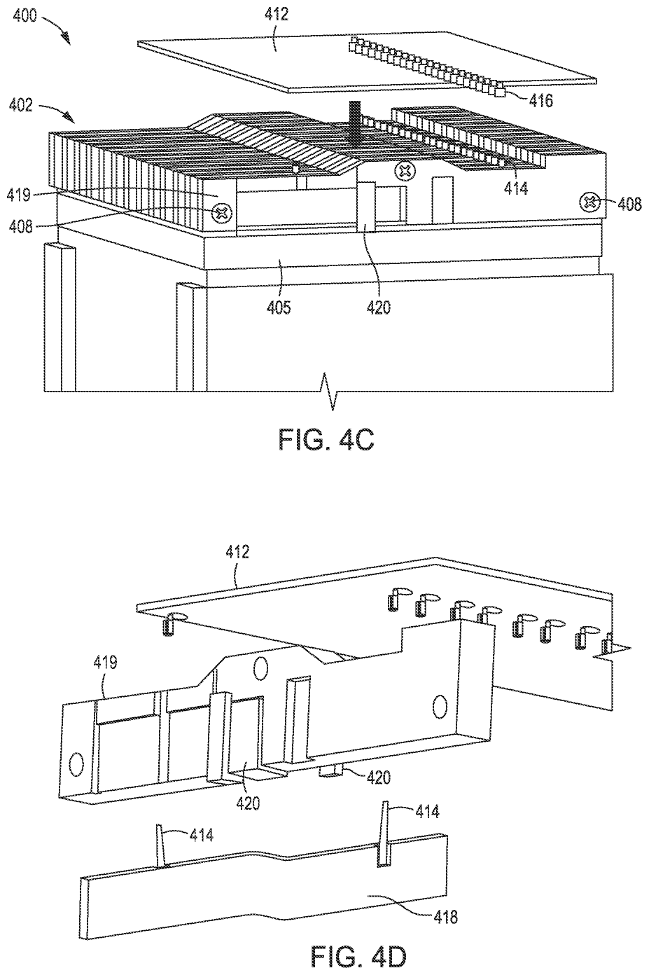

FIGS. 4A-4D are diagrams of pouch cell electrical configurations 400, in accordance with one or more embodiments of the present disclosure. As shown in FIGS. 4A-4C, a connecting/disconnecting device 402 of a plurality a battery cells 404 can comprise a preassembled clamp assembly 406, which can include individual clamps 407 that are loosely attached to each other with one or more screws 408 (long screws) that extend through the clamp assembly 406. For example, each pouch cell tab 411 of a battery cell 405 can be positioned between each pair of individual clamps 407 of the clamp assembly 406. Once each pouch cell tab 411 is positioned between each pair of individual clamps 407, the one or more screws 408 can be tightened to secure the plurality of battery cells 404 to the clamp assembly 406. The clamp assembly 406, which includes one or more quick connect/disconnect devices 414 (e.g., a second electrical connector, such as a pre-welded pin), can then be releasably connected (e.g., plug into) to a PCBA 412, which has first electrical connectors 416, e.g., for providing at least one of electrical interconnection, routing, voltage sensing, or temperature sensing. In at least some embodiments, the PCBA 412 can be configured for providing electrical interconnection, routing, and voltage sensing. Additionally, a Z-bend bus bar 418 can be connected to the clamp assembly 406. For example, end clamps 419 of the clamp assembly 406 can comprise brackets 420 that are configured as bus bar holders, e.g., the Z-bend bus bar 418 can be snapped into place on the end clamps 419 using the brackets 420. The Z-bend bus bar 418 can have one or more quick connect/disconnect devices 414 (two shown in FIG. 4D) that releasably connect to first electrical connectors 416, e.g., for providing at least one of electrical interconnection, routing, voltage sensing, or temperature sensing. For example, in at least some embodiments, the first electrical connectors 416 can be configured for providing voltage sensing and/or temperature sensing.

In use, when a battery cell 405 needs to be replaced, the PCBA 412 can be removed from the plurality of battery cells 404 by pulling the PCBA 412 from the plurality of battery cells 404 to disengage the one or more quick connect/disconnect devices 414 from the first electrical connector 416. Thereafter, the one or more screws 408 can be loosened so that the individual clamps 407 can be separated and the pouch cell tab 411 of the bad battery cell (or battery cells) can be removed from the clamp assembly 406. Once the bad battery cell is replaced with a new battery cell, all components can be reattached, e.g., pouch cell tab 411 of the new battery cell can be positioned between the individual clamps 407, the one or more screws 408 can be tightened, and the PCBA 412 reattached to the battery cells 404, as described above.

While the foregoing is directed to embodiments of the present disclosure, other and further embodiments of the disclosure may be devised without departing from the basic scope thereof, and the scope thereof is determined by the claims that follow.

What is claimed is:

1. An energy storage system, comprising:
a printed circuit board assembly configured to connect to a chassis of the energy storage system; and
a battery cell comprising a connecting/disconnecting device configured to engage a corresponding connecting/disconnecting device on the printed circuit board assembly for providing at least one of electrical interconnection, routing, voltage sensing, or temperature sensing.

2. The energy storage system of claim 1, wherein the connecting/disconnecting device of the printed circuit board assembly comprises a slot and the connecting/disconnecting device of the battery cell comprises a metal tab configured to be received within the slot and soldered thereto.

3. The energy storage system of claim 2, wherein the metal tab is made from nickel, and wherein the metal tab is at least one of spot welded or soldered to the printed circuit board assembly.

4. The energy storage system of claim 1, wherein the connecting/disconnecting device of the printed circuit board assembly comprises a socket and the connecting/disconnecting device of the battery cell comprises a protrusion configured to releasably engage the socket.

5. The energy storage system of claim 4, wherein the socket and the protrusion are each made from at least one of plastic or metal, and wherein the protrusion is at least one of spot welded or soldered to the battery cell.

6. The energy storage system of claim 1, wherein the connecting/disconnecting device of the printed circuit board assembly comprises a first electrical connector and the connecting/disconnecting device of the battery cell comprises an overlay embedded with a bus bar that is connected to the battery cell, and wherein the overlay comprises a second electrical connector configured to releasably engage the first electrical connector.

7. The energy storage system of claim 6, wherein the overlay is made from at least one of plastic or metal, and wherein the second electrical connector extends from a top surface of the overlay.

8. The energy storage system of claim 1, wherein the connecting/disconnecting device of the printed circuit board assembly comprises a first electrical connector and the connecting/disconnecting device of the battery cell comprises a clamp assembly comprising a second electrical connector configured to releasably engage the first electrical connector.

9. The energy storage system of claim 8, wherein the clamp assembly further comprises a plurality of individual clamps coupled to each other via a plurality of screws that extend through the clamp assembly.

10. The energy storage system of claim 1, wherein the battery cell is one of a cylindrical battery cell, a prismatic battery cell, or a pouch battery cell.

11. The energy storage system of claim 1, wherein the printed circuit board assembly is one of embedded in the chassis or connected to the chassis using at least one of nuts, bolts, screws, or adhesives.

12. An energy management system, comprising:
a distributed energy resource comprising a renewable energy source;
a load center connected to the renewable energy source; and
an energy storage system, comprising:
a printed circuit board assembly configured to connect to a chassis of the energy storage system; and
a battery cell comprising a connecting/disconnecting device configured to engage a corresponding connecting/disconnecting device on the printed circuit board assembly for providing at least one of electrical interconnection, routing, voltage sensing, or temperature sensing.

13. The energy management system of claim 12, wherein the connecting/disconnecting device of the printed circuit board assembly comprises a slot and the connecting/disconnecting device of the battery cell comprises a metal tab configured to be received within the slot and soldered thereto.

14. The energy management system of claim 13, wherein the metal tab is made from nickel, and wherein the metal tab is at least one of spot welded or soldered to the printed circuit board assembly.

15. The energy management system of claim 12, wherein the connecting/disconnecting device of the printed circuit board assembly comprises a socket and the connecting/disconnecting device of the battery cell comprises a protrusion configured to releasably engage the socket.

16. The energy management system of claim 15, wherein the socket and the protrusion are each made from at least one of plastic or metal, and wherein the protrusion is at least one of spot welded or soldered to the battery cell.

17. The energy management system of claim 12, wherein the connecting/disconnecting device of the printed circuit board assembly comprises a first electrical connector and the connecting/disconnecting device of the battery cell comprises an overlay embedded with a bus bar that is connected to the battery cell, and wherein the overlay comprises a second electrical connector configured to releasably engage the first electrical connector.

18. The energy management system of claim 17, wherein the overlay is made from at least one of plastic or metal, and wherein the second electrical connector extends from a top surface of the overlay.

19. The energy management system of claim 12, wherein the connecting/disconnecting device of the printed circuit board assembly comprises a first electrical connector and the connecting/disconnecting device of the battery cell comprises a clamp assembly comprising a second electrical connector configured to releasably engage the first electrical connector.

20. The energy management system of claim 19, wherein the clamp assembly further comprises a plurality of individual clamps coupled to each other via a plurality of screws that extend through the clamp assembly.
